(19) United States
(12) Patent Application Publication
(10) Pub. No.: US 2019/0155735 A1
(43) Pub. Date: May 23, 2019

(54) Data Software System Assist

(71) Applicant: NVXL Technology, Inc., Fremont, CA (US)

(72) Inventors: Bharadwaj Pudipeddi, San Jose, CA (US); Richard A. Cantong, Fremont, CA (US); Marlon B. Verdan, Fremont, CA (US); Joevanni Parairo, Fremont, CA (US); Marvin Fenol, Manila (PH)

(21) Appl. No.: 16/024,728

(22) Filed: Jun. 29, 2018

Related U.S. Application Data
(60) Provisional application No. 62/526,472, filed on Jun. 29, 2017.

(51) Int. Cl. G06F 12/0868; G06F 12/0871; G06F 12/0891; G06F 9/38

(52) U.S. Cl. CPC G06F 12/0868; G06F 9/3851; G06F 12/0891; G06F 12/0871

(57) ABSTRACT

In an embodiment of the invention, an apparatus comprises: a central processing unit (CPU); a volatile memory controller; a non-volatile memory controller; a volatile memory coupled to the volatile memory controller; and a non-volatile memory coupled to the non-volatile memory controller; wherein a ratio of the non-volatile memory to the volatile memory is much less than a typical ratio. In another embodiment of the invention, a method comprises: receiving, by a Central Processing Unit (CPU) receives a command; evaluating, by the CPU, the command; executing, by the CPU, a data software assist to perform the command or activating, by the CPU, a hardware accelerator module to perform the command; and responding, by the CPU, to the command. In yet another embodiment of the invention, an article of manufacture comprises: a non-transitory computer-readable medium having stored thereon instructions operable to permit an apparatus to perform a method comprising: receiving, by a Central Processing Unit (CPU) receives a command; evaluating, by the CPU, the command; executing, by the CPU, a data software assist to perform the command or activating, by the CPU, a hardware accelerator module to perform the command; and responding, by the CPU, to the command.

### CROSS-REFERENCE(S) TO RELATED APPLICATION

This application claims the benefit of and priority to U.S. Provisional Application No. 62/526,472 which was filed on Jun. 29, 2017. This U.S. Provisional Application No. 62/526,472 is hereby fully incorporated herein by reference.

### FIELD

Embodiments of the invention relate generally to the field of data storage systems.

### DESCRIPTION OF RELATED ART

The background description provided herein is for the purpose of generally presenting the context of the disclosure of the invention. Work of the presently named inventors, to the extent the work is described in this background section, as well as aspects of the description that may not otherwise qualify as prior art at the time of filing, are neither expressly nor impliedly admitted as prior art against this present disclosure of the invention.

Database Management Systems (such as, e.g., In-memory data structure) store a type of database and promise fast performance.

Cluster Computing Systems likewise promise fast performance.

Conventional data storage systems do not provide features that can accelerate, augment, or complement the fast performance promised by the data software systems mentioned above.

Therefore, there is a continuing need to overcome the constraints and/or disadvantages of conventional approaches.

### SUMMARY

Embodiments of the invention relate generally the field of data storage systems.

In an embodiment of the invention, an apparatus comprises: a central processing unit (CPU); a volatile memory controller; a non-volatile memory controller; a volatile memory coupled to the volatile memory controller; and a non-volatile memory coupled to the non-volatile memory controller; wherein a ratio of the non-volatile memory to the volatile memory is much less than a typical ratio.

In another embodiment of the invention, a method comprises: receiving, by a Central Processing Unit (CPU) receives a command; evaluating, by the CPU, the command; executing, by the CPU, a data software assist to perform the command or activating, by the CPU, a hardware accelerator module to perform the command; and responding, by the CPU, to the command.

In yet another embodiment of the invention, an article of manufacture comprises: a non-transitory computer-readable medium having stored thereon instructions operable to permit an apparatus to perform a method comprising: receiving, by a Central Processing Unit (CPU) receives a command; evaluating, by the CPU, the command; executing, by the CPU, a data software assist to perform the command or activating, by the CPU, a hardware accelerator module to perform the command; and responding, by the CPU, to the command.

It is to be understood that both the foregoing general description and the following detailed description are exemplary and explanatory only and are not restrictive of the invention, as claimed. For example, the foregoing general description presents a simplified summary in order to provide a basic understanding of some aspects described herein. This summary is not an extensive overview of the claimed subject matter. This summary is intended to neither identify key or critical elements of the claimed subject matter nor delineate the scope thereof. The sole purpose of the summary is to present some concepts in a simplified form as a prelude to the more detailed description that is presented later.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

It is to be noted, however, that the appended drawings illustrate only typical embodiments of this invention and are therefore not to be considered limiting of its scope, for the present invention may admit to other equally effective embodiments.

FIG. 1 is a block diagram of a system, in accordance with an embodiment of the invention.

FIG. 2 is a block diagram of a system comprising a data management device, in accordance with another embodiment of the invention.

FIG. 3 is a block diagram of elements used in a system in one scenario, in accordance with an embodiment of the invention.

FIG. 4 is a block diagram of elements used in a system in another scenario, in accordance with an embodiment of the invention.

FIG. 5 is a flow diagram of a method, in accordance with an embodiment of the invention.

### DETAILED DESCRIPTION

In the following detailed description, for purposes of explanation, numerous specific details are set forth to provide a thorough understanding of the various embodiments of the present invention. Those of ordinary skill in the art will realize that these various embodiments of the present invention are illustrative only and are not intended to be limiting in any way. Other embodiments of the present invention will readily suggest themselves to such skilled persons having the benefit of this disclosure.

In addition, for clarity purposes, not all of the routine features of the embodiments described herein are shown or described. One of ordinary skill in the art would readily appreciate that in the development of any such actual implementation, numerous implementation-specific decisions may be required to achieve specific design objectives. These design objectives will vary from one implementation to another and from one developer to another. Moreover, it will be appreciated that such a development effort might be complex and time-consuming, but would nevertheless be a routine engineering undertaking for those of ordinary skill in the art having the benefit of this disclosure. The various embodiments disclosed herein are not intended to limit the scope and spirit of the herein disclosure.

Exemplary embodiments for carrying out the principles of the present invention are described herein with reference to the drawings. However, the present invention is not limited to the specifically described and illustrated embodiments. A person skilled in the art will appreciate that many other embodiments are possible without deviating from the basic concept of the invention. Therefore, the principles of the present invention extend to any work that falls within the scope of the appended claims.

As used herein, the terms “a” and “an” herein do not denote a limitation of quantity, but rather denote the presence of at least one of the referenced items.

In the following description and in the claims, the terms “include” and “comprise” are used in an open-ended fashion, and thus should be interpreted to mean “include, but not limited to . . . ”. Also, the term “couple” (or “coupled”) is intended to mean either an indirect or direct electrical connection (or an indirect or direct optical connection). Accordingly, if one device is coupled to another device, then that connection may be through a direct electrical (or optical) connection, or through an indirect electrical (or optical) connection via other devices and/or other connections.

An embodiment of the invention advantageously improves the performance of data software systems by interfacing at least one of the data software systems with devices having features that can accelerate, augment, or/and complement the data software systems.

An embodiment of the invention also provides a novel cache algorithm that advantageously provides low latency access to data.

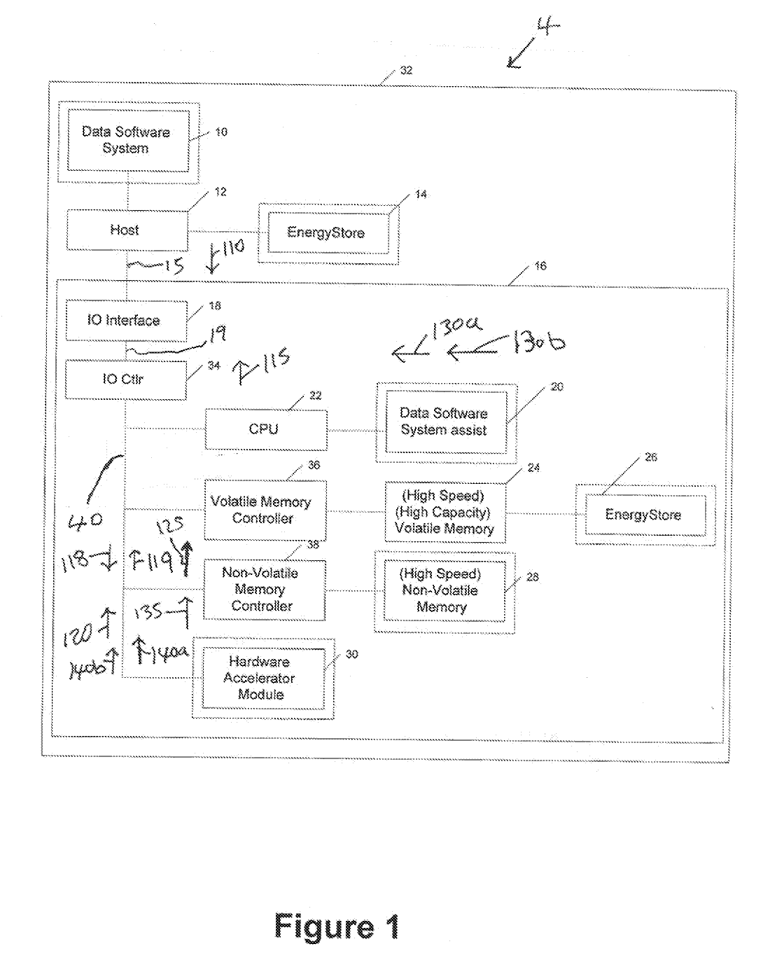

FIG. 1 is a block diagram of a system 4, in accordance with an embodiment of the invention. The system 4 comprises a data management appliance 32 that includes a host 12 and a data management device 16 that is communicatively coupled to the host 12. A data software system 10 is configured to run (and/or is running) in the host 12.

In one embodiment, the data software system 10 comprises a database management system which is computer software application that interacts with the user, one application or other applications, and/or the database itself to capture and analyze data. Examples of such software applications can be, for example, MySQL, MongoDB, or another type of software application for capturing and analyzing data.

In another embodiment or an alternative embodiment, the data software system 10 comprises a subset of a data management system. For example, a subset of a data management system is an In-memory data structure store 10 which is a database management system that primarily relies on a main memory for computer data storage (e.g., Redis which is an open source (BSD licensed) in-memory data structure store used as a database, cache, and/or message broker).

In one embodiment or an alternative embodiment, the data software system 10 comprises Data processing software (e.g., Apache Spark).

In one embodiment or an alternative embodiment, the data software system 10 comprises Data access software (e.g., Cassandra).

The host 12 executes one or more data software systems 10.

A host 12 can be defined as any device that has the ability to transmit a transaction request to the data management device 16. For example, this device (e.g., host 12) can generate a memory read transaction request or memory write transaction request and can receive a response resulting from the processing of the transaction request by the data management device 16.

The data management device 16 may process transaction requests from one or more requesting device, such as one or more hosts 12.

An energy store 14 is coupled to the host 12 and is an auxiliary power supply that provides power to the host 12 when brownout of the main power occurs. Similarly, an energy store 26 is coupled to and provides power to the volatile memory 24 in the data management device 16 when the power supply to the volatile memory 24 is interrupted. The energy store 14 or the energy store 26 can be a battery, capacitor power supply, unlimited power supply, any of the various types of super-capacitors (e.g., ultra-capacitor, ceramic capacitors, Tantalum capacitor, or another type of super-capacitor), or another type of power source.

In an embodiment of the invention, the host 12 is communicatively coupled via a link 15 to a data management device 16. The link 15 can be, by way of example and not by way of limitation, a communication bus (or communication buses) or a wireless communication link such as, by way of example and not by way of limitation, an optical communication link, a radio frequency (RF) communication link, or another type of wireless communication link.

As an example, the data management device 16 comprises an SSD (solid state drive). However, in another example, the data management device 16 comprises another type of device that is different from an SSD. Therefore, an SSD is just one embodiment of the data management device 16.

In an embodiment of the invention, the data management device 16 comprises an IC (input/output) interface 18, a central processing unit (CPU) 22, a hardware accelerator module 30, an IC controller 34, a volatile memory 24, an energy store 26, a non-volatile memory 28, a volatile memory controller 36, and a non-volatile memory controller 38. Details of the above components will be discussed below.

In an embodiment of the invention, the data management device 16 is connected to the host 12 and has features that assist the data software system 10 of the host 12. The data management device 16 is configured to accelerate, augment, or/and complement at least one data software system 10. In particular, the data software system assist 20 or the hardware accelerator module 30 is configured to accelerate, augment, or/and complement at least one data software system 10.

The IO interface 18 is coupled via the link 15 to the host 12 and via a link 19 to the IO controller 34. The link 19 can be, for example, a communication bus or another suitable communication link for communicatively coupling the IO interface 18 with the IO controller 34.

The IO interface 18 can be based on, for example, PCIe (Peripheral Component Interconnect Express), FC (Fibre Channel), Ethernet, Infiniband (IB), Quickpath, Omnipath, Interlaken, and/or another type of IO interface.

The IO controller 34 is a controller that is associated with the IO interface 18. The IO controller 34 controls the transmissions of signals to and from the CPU 22, volatile memory controller 36, non-volatile memory controller 38, and hardware accelerator 30.

The data software system assist 20 comprises a module, software, and/or algorithms running in the CPU 22 and the data software system assist 20 assists the database management system 10. The data software system assist 20 can be used in a variety of applications such as, for example, big data software, database application software, distributed computing software which can be software that needs to access data and/or that delegates a task (or tasks) to another host or module in a computing system, or another type of application. The elements in the data management device 16 can advantageously boost the performance of a software system such as, for example, the data software system 10. In other words, the data management device 16 comprises a platform for boosting the performance of a software system. For example, the data software system assist 20 and/or the hardware accelerator module 30 can advantageously boost the performance of the data software system 10.

The data software system assist 20 runs on (and/or is configured to run on) the CPU 22.

The hardware accelerator module 30 performs similar functions as the data software system assist 20 and provides similar advantages as the data software system assist 20.

The CPU 22 can be a processor of the data management device 16. The device management device 16 can comprise one or more CPUs 22.

The volatile memory controller 36 is coupled to the volatile memory 24. The volatile memory 24 can be, for example, a SRAM (static random access memory) or a DRAM (dynamic random access memory). In one embodiment or alternative embodiment, the volatile memory 24 can be further categorized as a high speed volatile memory and/or a high capacity volatile memory.

The volatile memory 24 is typically used as (and/or functions as) a cache for caching data that is read from and/or written to the non-volatile memory 28. Additionally, the volatile memory 24 stores a directory structure that maps out where to locate each unit of storage that is used in non-volatile memory 28 and/or used in another storage (e.g., hard disk drive) that can function with the data management device 16.

The volatile memory controller 36 permits memory transactions such as read or write memory transactions to be performed on the volatile memory 24.

The energy store 26 comprises an auxiliary power supply that provides power when brownout of the main power occurs. The energy store 26 may be a different embodiment as compared to an embodiment of the energy store 14, or the energy store 26 can be a similar embodiment as compared to an embodiment of the energy store 14.

The energy store 14 and/or energy store 26 ensure that the data in the host 12 and volatile memory 24, respectively, are protected in the event of power loss that affects the data management appliance 32. On power loss, processing of retained information in these components continues. For example, on power loss, the data in the volatile memory 24 are flushed to the non-volatile memory 28.

The non-volatile memory 28 can be, for example, a flash memory. In one embodiment or alternative embodiment, the non-volatile memory 28 can be further categorized as a high speed memory.

The non-volatile memory controller 38 permits memory transactions such as read or write memory transactions to be performed on the non-volatile memory 28.

The hardware accelerator module 30 can be, for example, a Convolution Module, a Matrix Multiplication Module, a FIR (finite impulse response) Filter module, a Video Translator Module, or another type of accelerator.

The CPU 22, volatile memory controller 36, non-volatile memory controller 38, and hardware accelerator module 30 are electrically coupled and/or communicatively coupled via a bus 40 to the IO controller 34 so that the IO controller 34 permits signal communications to occur between IO controller 34 and the CPU 22, volatile memory controller 36, non-volatile memory controller 38, and hardware accelerator module 30 and/or between the CPU 22 and other elements such as the volatile memory controller 36, non-volatile memory controller 38, or hardware accelerator module 30.

Examples of the Volatile Memory 24 and Non-Volatile Memory 28:

In an embodiment of the invention, the volatile memory 24 provides a non-volatile memory to cache ratio that is much less than a typical ratio. This is a ratio of the size of the non-volatile memory 28 to the size of the non-volatile memory 24: i.e., ratio=(size of non-volatile memory 28)/(size of volatile memory 24).

In one embodiment, the volatile memory 24 provides a non-volatile memory to cache ratio of less than approximately 500.

In another embodiment, the volatile memory 24 provides a non-volatile memory to cache ratio of equal to or less than approximately 125.

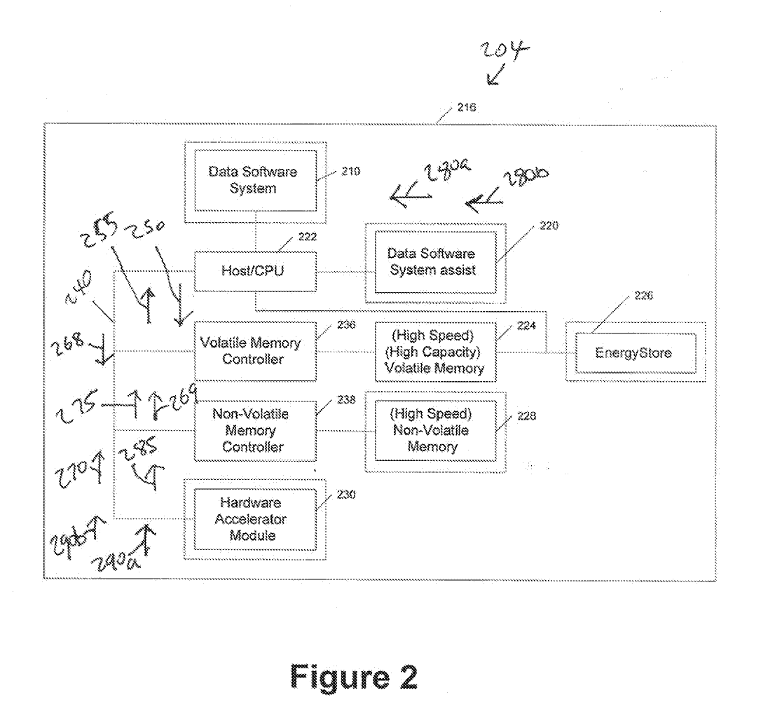

The size range of the non-volatile memory 28 (or the size range of the non-volatile memory 228 in FIG. 2) is typically in terabytes. The size range of the volatile memory 24 (or the size range of the volatile memory 224 in FIG. 2) is typically in gigabytes. In an embodiment of the invention, the size of the volatile memory 24 or the size of the volatile memory 224 is larger than the size of a volatile memory in a conventional system and approaches or falls in a size towards the size of the non-volatile memory 28 or the size of the non-volatile memory 228, respectively.

Interactions of Elements—Scenario #1:

The host 12 sends a data processing command 110 (e.g., count the number of instances of the word “hello” in all the cache lines 310) to the data management device 16 via vendor-specific-command(s) supported by an IC Interface protocol that is used by the IC interface 18.

The CPU 22 evaluates the data processing command 110.

The CPU 22 executes the data software assist 20 to perform the data processing command 110.

The CPU 22 responds back with the word count 115 to the host 12 in response to the data software assist 20 performing the data processing command 110.

Interaction of Elements—Scenario #2:

The host 12 sends a data processing command 110 (e.g., count the number of instances of the word “hello” in all the cache lines 310) to the data management device 16 via vendor-specific-command(s) supported by an IO Interface protocol that is used by the IO interface 18.

The CPU 22 evaluates the data processing command 110.

The CPU 22 activates (via command 118) the hardware accelerator module 30 to perform the data processing command 110.

The hardware accelerator module 30 accesses (119) the cache lines 310 in the volatile memory 24 (via the volatile memory controller 36) as part of the operations in the data processing command 110.

The hardware accelerator module 30 provides the result 120 of the operation (e.g., word count) to the CPU 22.

The CPU 22 responds back with the result 115 of the operation (total word count) to the host 12 based on the result 120 provided by the hardware accelerator module 30.

Interaction of Elements—Scenario #3:

The host 12 sends a data processing command 110 (e.g., count the number of instances of the word “hello” in all the entries of the data lookup 330) to the data management device 16 via vendor-specific-command(s) supported by an IO Interface protocol that is used by the IO interface 18.

The CPU 22 evaluates the data processing command 110.

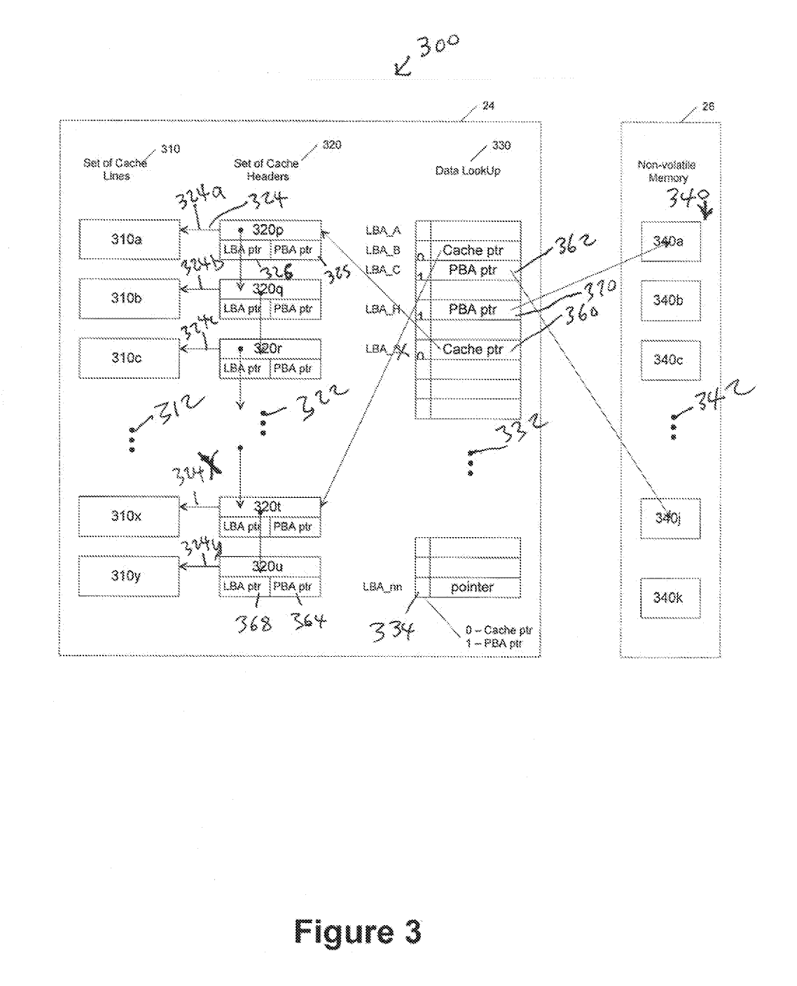

The CPU 22 loads (125) an initial set of sections (sections 340 such as, e.g., sections 340a and 340b in FIGS. 3 and/or 4) from the non-volatile memory 28 (via the non-volatile memory controller 38) to the cache lines 310 (FIGS. 3 and/or 4) in the volatile memory 24 (via the volatile memory controller 36).

The CPU 22 executes the data software system assist 20 to perform the data processing command 110 in the cache lines 310 (via the volatile memory controller 36).

The data software system assist 20 provides the partial word count 130a to the CPU 22.

The CPU 22 loads (125) a next set of sections (sections 340, such as, e.g., sections 340c and 340d) from the non-volatile memory 28 (via the non-volatile memory controller 38) to the cache lines 310 (via the volatile memory controller 36) and the data software system assist 20 performs the data processing command 110 in the cache lines 310 and the data software system assist 20 provides the partial word count 130b to the CPU 22. The above procedure is similarly repeated until all sections via the non-volatile memory 28 are processed by the data software system assist 20.

The CPU 22 responds back with the result 115 of the operation (total word count) to the host 12 based on all the partial word counts 130a and 130b.

Interaction of Elements—Scenario #4:

The host 12 sends a data processing command 110 (e.g., count the number of instances of the word “hello” in all the entries of the data lookup 330) to the data management device 16 via vendor-specific-command(s) supported by an IO Interface protocol that is used by the IO interface 18.

The CPU 22 evaluates the data processing command 110.

The CPU 22 loads (135) an initial set of sections 340 from the non-volatile memory 28 (via the non-volatile memory controller 38) to the cache lines 310 in the volatile memory 24 (via the volatile memory controller 36).

The CPU 22 activates the hardware accelerator module 30 to perform the data processing command 110.

The hardware accelerator module 30 accesses the cache lines 310 in the volatile memory 24 (via the volatile memory controller 36) as part of the operations in the data processing command 110.

The hardware accelerator module 30 provides the result 140a of the operation (partial word count) to the CPU 22.

The CPU 22 loads (135) a next set of sections 340 from the non-volatile memory 28 to the cache lines 310 and the hardware accelerator module 30 performs the data processing command 110 and accesses the cache lines 310 in the volatile memory 24 as part of the operations in the data processing command 110 and provides the result 140b of the operation (next partial word count) to the CPU 22. The above procedure is similarly repeated until all sections via the non-volatile memory 28 are processed by the hardware accelerator module 30.

The CPU 22 responds back with the result 115 of the operation (e.g., word count) to the host 12 based on all the results 140a and 140b.

FIG. 2 is a block diagram of a system 204 comprising a data management device 216, in accordance with another embodiment of the invention. In an embodiment of the invention, the data management device 216 comprises a data software system 210, a data software system assist 220, a host/CPU module 222, a hardware accelerator module 230, a volatile memory 224, an energy store 226, a non-volatile memory 228, a volatile memory controller 236, and a non-volatile memory controller 238. Details of the above components will be discussed below.

In an embodiment of the invention, the data management device 216 has features that assist the data software system 210. The data management device 216 is configured to accelerate, augment, or/and complement at least one data software system 210. In particular, the data software system assist 220 or the hardware accelerator module 230 is configured to accelerate, augment, or/and complement at least one data software system 210.

The data software system 210 is configured to run (and/or is running) in the host/CPU block 222 (e.g., shown in FIG. 2 as a host/CPU block 222).

The host/CPU block 222 acts as a host and performs similar operations as the host 12 in FIG. 1. The host/CPU block 222 also acts as a CPU and performs similar operations as the CPU 22 in FIG. 1.

The hardware accelerator module 230 performs similar functions as the data software system assist 220 and provides similar advantages as the data software system assist 220.

In one embodiment, the data software system 210 comprises a database management system which is a computer software application that interacts with the user, one application or other applications, and/or the database itself to capture and analyze data. Examples of such software applications can be, for example, MySQL, MongoDB, or another type of software application for capturing and analyzing data.

In another embodiment or an alternative embodiment, the data software system 210 comprises a subset of a data management system. For example, a subset of data management system is an In-memory data structure store 210 which is a database management system that primarily relies on a main memory for computer data storage (e.g., Redis which is an open source (BSD licensed) in-memory data structure store used as a database, cache, and/or message broker).

In one embodiment or an alternative embodiment, the data software system 210 comprises Data processing software (e.g., Apache Spark).

In one embodiment or an alternative embodiment, the data software system 210 comprises Data access software (e.g., Cassandra).

The host/CPU block 222 comprises a processor of the data management device 216 and executes the data software system 210. The data management device 216 can have one or more (at least one) host/CPU block 222.

The energy store 226 comprises an auxiliary power supply that provides power to the data management device 216 when brownout of the main power occurs. The data management device 216 can have one or more (at least one) energy store 226. An energy store 226 can be shared or not shared to many modules in the data management device 216. For example, each module in the data management device 216 can have a separate respective energy store 226. In one particular example, the host/CPU block 222 and volatile memory 224 can share and receive power from the same energy store 226. In another particular example, the host/CPU block 222 can receive power from a first energy store (which similar to an energy store 226) and the volatile memory 224 can receive power from a second energy store. The energy store 226 and/or any other additional energy store in the data management device 216 can be a battery, capacitor power supply, unlimited power supply, any of the various types of super-capacitors (e.g., ultra-capacitor, ceramic capacitors, Tantalum capacitor, or another type of super-capacitor), or another type of power source.

The data management device 216 comprises a device which runs the data software system 210.

The data software system assist 220 comprises a module, software, and/or algorithms running in the CPU component of the host/CPU 222 and which assists the data software system 210.

The volatile memory 224 can be, for example, a SRAM or a DRAM. The volatile memory 224 can be further categorized as a high speed memory and/or a high capacity memory in at least one alternate embodiment or in at least one embodiment.

The non-volatile memory 228 can be, for example, a flash memory. The non-volatile memory 228 can be further categorized as a high speed memory in at least one alternate embodiment or at least one embodiment.

The hardware accelerator module 230 can be, for example, a Convolution Module, a Matrix Multiplication Module, a FIR Filter module, a Video Translator Module, or another type of accelerator.

The host/CPU block 222, volatile memory controller 236, non-volatile memory controller 238, and hardware accelerator module 230 are electrically coupled and/or communicatively coupled via a bus 240 so that signal communications occur between the host/CPU block 222, volatile memory controller 236, non-volatile memory controller 238, and hardware accelerator module 230.

Examples of the Volatile Memory 224 and Non-Volatile Memory 228:

In an embodiment, the volatile memory 224 provides a non-volatile memory to cache ratio that is much less than the typical ratio. As similarly discussed above, the non-volatile memory to cache ratio is a ratio of the size of the non-volatile memory 228 and the size of volatile memory 224.

In one embodiment, the volatile memory 224 provides a non-volatile memory to cache ratio of less than approximately 500.

In another embodiment, the volatile memory 224 provides a non-volatile memory to cache ratio of equal or less than approximately 125.

The interaction of the elements in the data management device 216 is the same and/or similar to the scenarios discussed above for the elements in FIG. 1. However, the host component in the host/CPU block 222 would send a data processing command 250 (similar to the data processing command 110 in FIG. 1) that would be processed by the CPU component in the host/CPU block 222 in similar manners as discussed above for the command 110 in the above-discussed example scenarios in the interaction of elements. The host component in the host/CPU block 222 would receive a result 255 which would be similar to the result 115 in FIG. 1 in response to a data processing command 250 for the above-discussed example scenarios in the interaction of elements.

Specific examples of the interaction of elements in the system 204 in FIG. 2 are now discussed.

Interactions of Elements—Scenario #1:

The host/CPU block 222 evaluates a data processing command 250 (e.g., count the number of instances of the word “hello” in all the cache lines 310).

The host/CPU block 222 executes the data software assist 220 to perform the data processing command 250.

The host/CPU block 222 generates the word count 255 in response to the data software assist 220 performing the data processing command 250.

Interaction of Elements—Scenario #2:

The host/CPU block 222 evaluates a data processing command 250 (e.g., count the number of instances of the word “hello” in all the cache lines 310).

The host/CPU block 222 activates (via command 268) the hardware accelerator module 230 to perform the data processing command 250.

The hardware accelerator module 230 accesses (269) the cache lines 310 in the volatile memory 224 (via the volatile memory controller 236) as part of the operations in the data processing command 250.

The hardware accelerator module 230 provides the result 270 of the operation (e.g., word count) to the host/CPU block 255.

The host/CPU block 222 provides the result 255 based on the result 270 provided by the hardware accelerator module 230.

Interaction of Elements—Scenario #3:

The host/CPU block 222 evaluates a data processing command 250 (e.g., count the number of instances of the word “hello” in all the entries of the data lookup 330).

The host/CPU block 222 loads (275) an initial set of sections (sections 340 such as, e.g., sections 340a and 340b) from the non-volatile memory 228 (via the non-volatile memory controller 238) to the cache lines 310 in the volatile memory 224 (via the volatile memory controller 236).

The host/CPU block 222 executes the data software system assist 220 to perform the data processing command 250 in the cache lines 310 in the volatile memory 224 (via the volatile memory controller 236).

The data software system assist 220 provides the partial word count 280a to the host/CPU block 222.

The host/CPU block 222 loads (275) a next set of sections (sections 340, such as, e.g., sections 340c and 340d) from the non-volatile memory 228 (via the non-volatile memory controller 238) to the cache lines 310 in the volatile memory 224 (via the volatile memory controller 236) and the data software system assist 220 performs the data processing command 250 in the cache lines 310 and the data software system assist 220 provides the partial word count 280b to the host/CPU block 222. The above procedure is similarly repeated until all sections via the non-volatile memory 228 are processed by the data software system assist 220.

The host/CPU block 222 provides the result 255 of the operation (total word count) based on all the partial word counts 280a and 280b.

Interaction of Elements—Scenario #4:

The host/CPU block 222 evaluates a data processing command 250 (e.g., count the number of instances of the word “hello” in all the entries of the data lookup 330).

The host/CPU block 222 loads (285) an initial set of sections 340 from the non-volatile memory 228 (via the non-volatile memory controller 238) to the cache lines 310 in the volatile memory 224 (via the volatile memory controller 236).

The host/CPU block 222 activates the hardware accelerator module 230 to perform the data processing command 250.

The hardware accelerator module 230 accesses the cache lines 310 in the volatile memory 224 (via the volatile memory controller 236) as part of the operations in the data processing command 250.

The hardware accelerator module 230 provides the result 290a of the operation (partial word count) to the host/CPU block 222.

The host/CPU block 222 loads (285) a next set of sections 340 from the non-volatile memory 228 to the cache lines 310 and the hardware accelerator module 230 performs the data processing command 250 and accesses the cache lines 310 in the volatile memory 224 as part of the operations in the data processing command 250 and provides the result 290b of the operation (next partial word count) to the host/CPU block 222. The above procedure is similarly repeated until all sections via the non-volatile memory 228 are processed by the hardware accelerator module 230.

The host/CPU block 222 provides the result 255 of the operation (e.g., word count) based on all the results 290a and 290b.

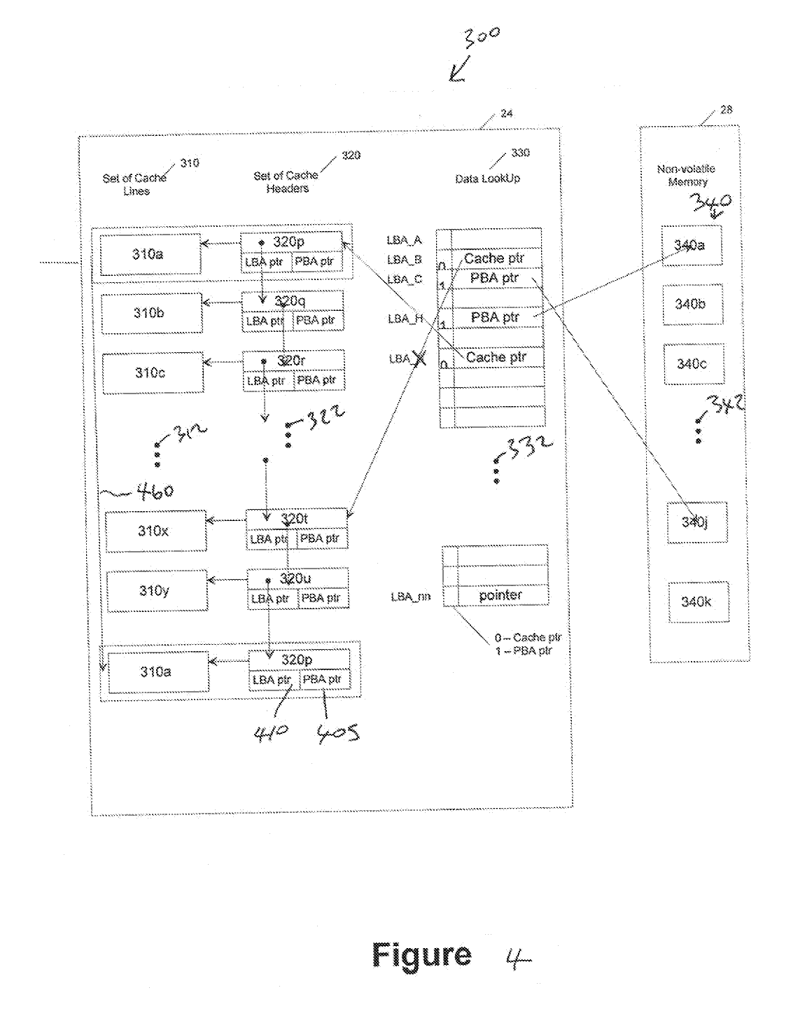

FIG. 3 is a block diagram of elements used in a system 300 in one scenario, in accordance with an embodiment of the invention. FIG. 4 is a block diagram of the same system 300 having similar elements as in FIG. 3, but in another scenario, in accordance with an embodiment of the invention. The system 300 can be the system 4 in FIG. 1 or the system 204 in FIG. 2. The volatile memory 24 in the system 300 can be the same as the volatile memory 24 in the system 4 or can be the same as the volatile memory 224 in the system 204. The non-volatile memory 28 in the system 300 can be the same as the non-volatile memory 28 in the system 4 or can be the same as the volatile memory 228 in the system 204.

In the discussion below, the details regarding (and/or included in) the volatile memory 24 and the non-volatile memory 28 can be details that are also applicable to (and/or also included in) the volatile memory 224 and the non-volatile memory 228, respectively.

The volatile memory 24 (or volatile memory 224) stores the set of cache lines 310, set of cache headers 320, and data lookup 330, as will be discussed below. The non-volatile memory 28 (or non-volatile memory 228) stores the sections 340, as will be discussed below.

The data lookup 330 comprises a table having a linear list of pointers, in one embodiment of the invention. A pointer in the data lookup 330 is a cache pointer that is associated with a memory location inside an SRAM. The PBA (physical block address) pointer is associated with a section 340 in the non-volatile memory 28. Whenever a firmware or a software presents an LBA (logical block address) to the data lookup 330, the data lookup 330 determines a cache pointer or a PBA pointer that is associated with that LBA.

The set of cache headers 320 can be a linked list, in an embodiment of the invention. However, the set of cache headers 320 can be implemented by use of other types of data structures.

The number of cache lines 310 in the volatile memory 24 (or volatile memory 224) may vary as shown by the dot symbols 312. In the example of FIG. 3, the cache lines 310 comprise the cache lines 310a, 310b, 310c, through 310x and 310y. A given cache line 310 (e.g., any of the cache lines 310a through 310y) is a basic unit of cache storage.

The number of cache headers 320 in the volatile memory 24 (or volatile memory 224) may vary as shown by the dot symbols 322. In the example of FIG. 3, the cache headers 320 comprise the cache headers 320p, 320q, 320r, through 320t and 320u.

The set of cache headers 320 may, for example, be implemented as a table 320, linked-list 320, or other data structure 320.

Each cache header 320 is associated with a given cache line 310. For example, the cache headers 320p, 320q, 320r, 320t, and 320u is associated with the cache lines 310a, 310b, 310c, 310x, and 310y, respectively. Each cache header 320 contains metadata 324 associated with a cache line 310. For example, each cache header 320 contains the pointer 324 or index location (324) of its associated cache line 310. In the example of FIG. 3, the cache header 320p contains a metadata 324a (e.g., pointer 324a or index location 324a) that associates the cache header 320p to the cache line 310a; the cache header 320q contains a metadata 324b that associates the cache header 320q to the cache line 310b; the cache header 320r contains a metadata 324c that associates the cache header 320r to the cache line 310c; the cache header 320t contains a metadata 324x that associates the cache header 320t to the cache line 310x; and the cache header 320u contains a metadata 324y that associates the cache header 320u to the cache line 310y.

When a cache header pointer 324 or index location 324 is recorded as a valid entry in the data lookup table 330, one of the metadata 325 contained in the cache header 320 is the non-volatile PBA (physical block address) location (i.e., PBA pointer 325) associated with the data contents of the cache line entry 310 associated with the cache header 320.

When a cache header pointer 324 or index location 324 is recorded as a valid entry in data lookup table 330, one of the metadata 326 contained in the cache header 320 is the LBA (logical block address) pointer 326 or index location 326 where the cache header location is recorded within the data lookup table 330.

The number of logical block addresses (LBAs) in the data lookup 320 in the volatile memory 24 (or volatile memory 224) may vary as shown by the dot symbols 332. In the example of FIG. 3, the logical block addresses comprise LBA_A, LBA_B, LBA_C, through LBA_H and LBA_X and LBA_nn.

A respective logical block address entry (e.g., LBA_nn) in the data lookup 330 has a respective pointer value field 334. For example, if the field 334 in the entry LBA_nn has a first value (e.g., logical 0 value), then the entry LBA_nn contains a cache pointer, and if the field 334 in the entry LBA_nn has a second value (e.g., logical 1 value), then the entry LBA_nn contains a PBA pointer.

The data lookup 330 can, for example, be embodied as a table or a list.

The data lookup 330 maps LBA pointers or indices to either a non-volatile memory PBA location or a volatile memory location.

One embodiment of mapping uses a bit field to indicate the pointer type, e.g., either a cache ptr or PBA ptr for each of the valid entries of the data lookup 330. For example, a respective given logical block address entry (e.g., LBA_nn) in the data lookup 330 has a respective pointer value field 334. As an example, if the field 334 in the entry LBA_nn has a first value (e.g., logical 0 value), then the entry LBA_nn contains a cache pointer, and if the field 334 in the entry LBA_nn has a second value (e.g., logical 1 value), then the entry LBA_nn contains a PBA pointer. Other embodiments are likewise permissible.

The lookup entries contains pointers or indices to PBA locations for the non-volatile memory 28.

The lookup entries contains pointers or indices to cache header locations for the volatile memory 24.

It is noted that in a preferred embodiment or an ideal embodiment, the entire contents of the data lookup 330 comprising all the addressable cache (volatile memory 24 or volatile memory 224) and section storage (non-volatile memory 28 or non-volatile memory 228) are completely stored in the volatile memory 24 (or volatile memory 224).

An alternate embodiment is when the data lookup 330 is partially stored in the non-volatile memory 28 (or non-volatile memory 228) as well.

The number of sections 340 in the non-volatile memory 28 (or non-volatile memory 228) may vary as shown by the dot symbols 342. In the example of FIG. 3, the sections 340 comprise the sections 340a, 340b, 340c, through 340j and 340k. A section 340 is a basic unit of a non-volatile storage from the CPU 22 point of view (or point of view of the CPU element in the block 222).

The volatile memory 24 (or volatile memory 224) can, be for example, a SRAM or a DRAM. The volatile memory 24 (or volatile memory 224) can be further categorized as a high speed memory and/or as a high capacity memory in an embodiment or in alternate embodiments.

The non-volatile memory 28 (or non-volatile memory 228) can be, for example, a flash memory. The non-volatile memory 28 (or non-volatile memory 228) can be further categorized as a high speed memory in an embodiment or in alternate embodiments.

The various methods described herein with reference to FIGS. 3 and 4 provide novel ways to reduce the response time of a system (e.g., data management device 16 or data management device 216) to a request.

Interactions of Elements—Scenario #1 (Cache Hit):

The host 12 sends a read LBA request to the data management device 16.

After the CPU 22 receives the request, the CPU 22 checks the pointer 360 associated with the LBA (e.g., LBA_X) using the data lookup 330.

The pointer 360 is a cache pointer pointing to cache header 320p, so that the CPU 22 sets up the IC controller 32 to send the contents of the cache line (e.g., cache line 310a) associated with LBA_X to the host 12. Note that the cache header 320p contains a metadata 324a (e.g., pointer 324a or index location 324a) that associates the cache header 320p to the cache line 310a.

Note also that the read LBA request can be sent by the host/CPY block 222 (FIG. 2) in the data management device 222, and the same process as similarly discussed above is performed.

Interactions of Elements—Scenario #2 (Cache Miss—Example 1):

1. The host 12 sends a read LBA request to the data management device 16.

2. After the CPU 22 receives the request, the CPU 22 checks the pointer 362 associated with the LBA (e.g., LBA_C) using the data lookup 330.

3. The pointer 362 is a PBA pointer pointing to a section 340j in the non-volatile memory 28, so that the CPU 22 sets up the non-volatile memory controller 38 to send the contents of section 340j to a free cache line (e.g., cache line 310y) associated with cache header 320u. Note that the cache header 320u contains a metadata 324y (e.g., pointer 324ay or index location 324y) that associates the cache header 320u to the cache line 310y.

4. The CPU 22 sets up the IO controller 34 to send the contents of the cache line 310y associated with LBA_C to the host 12.

5. The CPU 22 does the following:

a. In the data lookup 330, the CPU 22 replaces the PBA pointer 362 pointing to a section 340j in the non-volatile memory 28, with the Cache pointer associated with cache header 320u and cache line 310y.

b. The CPU 22 saves the PBA pointer pointing to a section 340j in the non-volatile memory 28 within one of the fields 364 in the cache header 320u.

c. The CPU 22 saves the LBA, in this case LBA_C, within one of the fields 368 in the cache header 320u.

Therefore, after the IO controller 34 sends the contents of the cache line 310y to the host 12, the CPU 22 updates the set of cache headers 320 (for example, as discussed above for cache header 320u) and data lookup 330 as discussed above.

Note also that the read LBA request can be sent by the block 222 (FIG. 2) in the data management device 222, and the same process as similarly discussed above is performed.

Interactions of Elements—Scenario #3 (Cache Miss—Example 2):

1. The host 12 sends a read LBA request to the data management device 16.

2. Once the CPU 22 receives the request, the CPU 22 checks the pointer 370 associated with the LBA (e.g. LBA_H) using the data lookup 330.

3. The pointer 370 is a PBA pointer pointing to a section 340a in the non-volatile memory 28, so that the CPU 22 sets up the non-volatile memory controller 38 to send the contents of section 340a to a freed up cache line 310a associated with the cache header 320p.

a. In an embodiment wherein the set of cache headers are arranged in a linked list, and a cache eviction policy of LRU (least recently used) is implemented, the freed up cache line 310a associated with the cache header 320p is chosen because the cache header 320p is the head of the linked list (see cache header 320p in FIG. 4), and hence the least recently used.

b. In order to free a cache line 310a associated with the cache header 320p, the PBA ptr recorded as metadata in cache header 320p is saved in the Data Lookup 330 in the location associated with the LBA ptr (in this case LBA_X), recorded as metadata in the cache header 320p.

c. The aforementioned cache header 320p will also be removed from the linked list but will remain as a floating node.

4. The CPU 22 sets up the IO controller 34 to send the contents of the cache line 310a associated with LBA_H to the host 12.

5. The CPU 22 does the following:

a. In the data lookup 330, the CPU 22 replaces the PBA pointer pointing to a section 340j in the non-volatile memory 28, with the cache pointer associated with the cache header 320p and the cache line 310a.

b. The CPU 22 saves the PBA pointer pointing to a section 340j in the non-volatile memory 28 within one of the fields 405 (FIG. 4) in the cache header 320p (FIG. 4).

c. The CPU 22 saves the LBA, in this case LBA_H within one of the fields 410 (FIG. 4) in the cache header 320p (FIG. 4).

d. In an embodiment wherein the set of cache headers are arranged in a linked list, and a cache eviction policy of LRU (least recently used) is implemented, the CPU 22 puts (460) the cache header 320p at the tail of the linked list 320, making the aforementioned cache header 320p as the most recently used.

6. Other cache eviction policies can be implemented in alternate embodiments of the invention.

Note also that the read LBA request can be sent by the block 222 (FIG. 2) in the data management device 216, and the same process as similarly discussed above is performed.

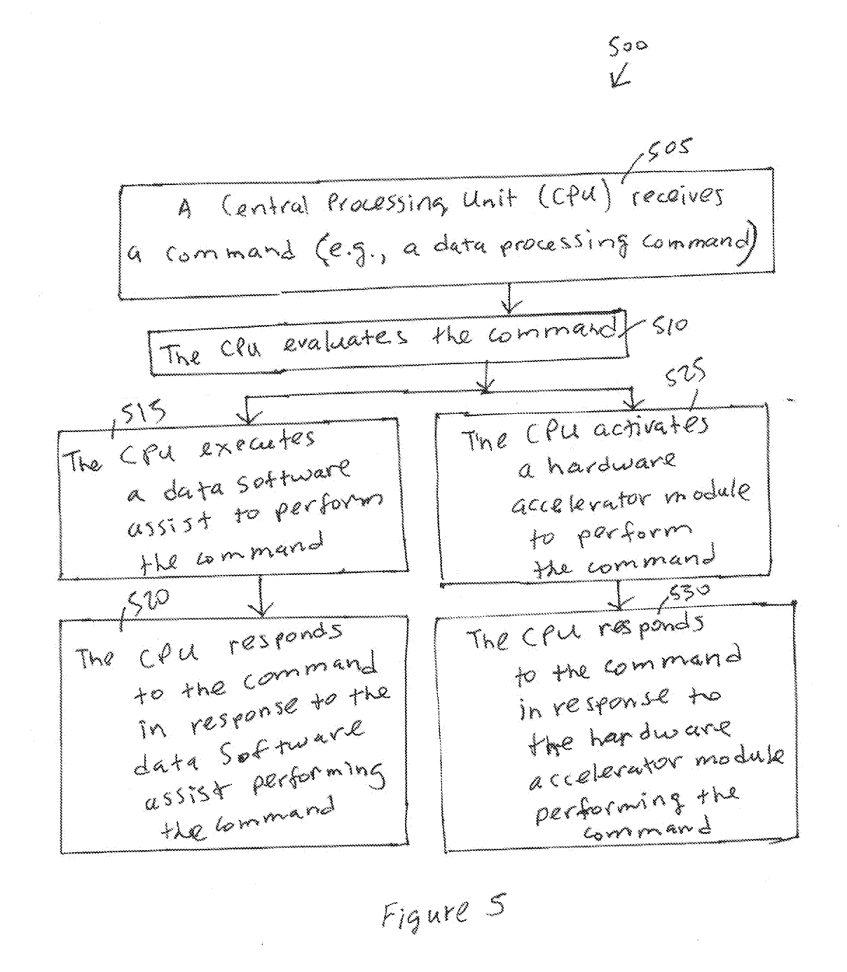

FIG. 5 is a flow diagram of a method 500, in accordance with an embodiment of the invention.

At 505, a Central Processing Unit (CPU) receives a command (e.g., a data processing command).

At 510, the CPU evaluates the command.

The method 500 can then either perform the steps in block 515 or block 520.

If the method performs the step in block 515 after performing the step in block 510, then the method 500 proceeds according to the following. At 515, the CPU executes a data software assist to perform the command.

At 520, the CPU responds to the command in response to the data software assist performing the command.

If the method performs the step in block 525 after performing the step in block 510, then the method 500 proceeds according to the following. At 525, the CPU activates a hardware accelerator module to perform the command.

At 530, the CPU responds to the command in response to the hardware accelerator module performing the command.

Note that one embodiment of the volatile memory 24 is NVRAM and the associated volatile memory controller 36 is NVRAM controller. Although the name is counter-intuitive, the NVRAM also serves the same function as a volatile memory. In this case, the persistence of data is built-in the NVRAM itself and the energy store 26 may not be necessary.

The word “exemplary” (or “example”) is used herein to mean serving as an example, instance, or illustration. Any aspect or embodiment or design described herein as “exemplary” or “example” is not necessarily to be construed as preferred or advantageous over other aspects or embodiments or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity and/or for purposes of focusing on the details of the subject innovation.

As used in herein, the terms “component”, “system”, “module”, “element”, and/or the like are intended to refer to a computer-related entity, either hardware, a combination of hardware and software, software, or software in execution. For example, a component or element may be, but is not limited to being, a process running on a processor, a processor, an object, an instance, an executable, a thread of execution, a program, and/or a computer. By way of example, both an application running on a computer and the computer can be a component. One or more components may reside within a process and/or thread of execution and a component may be localized on one computer and/or distributed between two or more computers.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless.

It is also within the scope of the present invention to implement a program or code that can be stored in a non-transient machine-readable medium (or non-transitory machine-readable medium or non-transient computer-readable medium or non-transitory computer-readable medium) having stored thereon instructions that permit a method (or that permit a computer) to perform any of the inventive techniques described above, or a program or code that can be stored in an article of manufacture that includes a non-transient computer readable medium (non-transitory computer readable medium) on which computer-readable instructions for carrying out embodiments of the inventive techniques are stored. Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
a central processing unit (CPU);
a volatile memory controller;
a non-volatile memory controller;
a volatile memory coupled to the volatile memory controller; and
a non-volatile memory coupled to the non-volatile memory controller;
wherein a ratio of the non-volatile memory to the volatile memory is much less than a typical ratio.

2. The apparatus of claim 1, wherein the ratio is less than approximately 500.

3. The apparatus of claim 1, wherein the ratio is less than approximately 125.

4. The apparatus of claim 1, further comprising:
a data software system assist that is configured to run on the CPU and that is configured to augment at least one data software system.

5. The apparatus of claim 1, further comprising:
a hardware accelerator module that is configured to augment at least one data software system.

6. The apparatus of claim 1, wherein the CPU is coupled via a link to a host.

7. The apparatus of claim 1, wherein the CPU is included in a block and wherein the block performs similar operations as a host.

8. The apparatus of claim 1, wherein the CPU executes a data software assist to perform a command.

9. The apparatus of claim 1, wherein the CPU activates a hardware accelerator module to perform a command.

10. The apparatus of claim 1, wherein during a cache hit, the CPU checks data lookup for a pointer associated with a logical block address (LBA) and sends a content of a cache line associated with the LBA in response to a read LBA request, wherein the pointer points to a cache header and wherein the cache header is associated with a cache line.

11. The apparatus of claim 1, wherein during a cache miss, the CPU set up the non-volatile memory controller to send a content in a section in the non-volatile memory to a free cache line associated with a cache header and sends the content in the free cache line in response to a read LBA request.

12. The apparatus of claim 1, wherein during a cache miss, the CPU sets up the non-volatile memory controller to send a content in a section in the non-volatile memory to a free cache line associated with a cache header and sends the content in the free cache line in response to a read LBA request and places the cache header at a location in a list depending on a cache eviction policy of the apparatus.

13. A method, comprising:
receiving, by a Central Processing Unit (CPU) receives a command;
evaluating, by the CPU, the command;
executing, by the CPU, a data software assist to perform the command or activating, by the CPU, a hardware accelerator module to perform the command; and
responding, by the CPU, to the command.

14. The method of claim 13, wherein the command comprises a data processing command.

15. The method of claim 13 wherein the CPU is included in an apparatus and wherein the apparatus comprises a ratio of a non-volatile memory to a volatile memory that is much less than a typical ratio.

16. The method of claim 15, wherein the ratio is less than approximately 500.

17. The method of claim 15, wherein the ratio is less than approximately 125.

18. The method of claim 13, wherein the data software system assist is configured to run on the CPU and that is configured to augment at least one data software system.

19. The method of claim 13, wherein the hardware accelerator module is configured to augment at least one data software system.

20. The method of claim 13, wherein the CPU is coupled via a link to a host.

21. The method of claim 13, wherein the CPU is included in a block and wherein the block performs similar operations as a host.

22. The method of claim 13, wherein during a cache hit, the CPU checks data lookup for a pointer associated with a logical block address (LBA) and sends a content of a cache line associated with the LBA in response to a read LBA request, wherein the pointer points to a cache header and wherein the cache header is associated with a cache line.

23. The method of claim 13, wherein during a cache miss, the CPU set up the non-volatile memory controller to send a content in a section in the non-volatile memory to a free cache line associated with a cache header and sends the content in the free cache line in response to a read LBA request.

24. The method of claim 13, wherein during a cache miss, the CPU sets up the non-volatile memory controller to send a content in a section in the non-volatile memory to a free cache line associated with a cache header and sends the content in the free cache line in response to a read LBA request and places the cache header at a location in a list depending on a cache eviction policy of the apparatus.

25. An article of manufacture, comprising:
a non-transitory computer-readable medium having stored thereon instructions operable to permit an apparatus to perform a method comprising:
receiving, by a Central Processing Unit (CPU) receives a command;
evaluating, by the CPU, the command;
executing, by the CPU, a data software assist to perform the command or activating, by the CPU, a hardware accelerator module to perform the command; and
responding, by the CPU, to the command.

26. The article of manufacture of claim 25, wherein the command comprises a data processing command.

27. The article of manufacture of claim 25 wherein the CPU is included in the apparatus and wherein the apparatus comprises a ratio of a non-volatile memory to a volatile memory that is much less than a typical ratio.

28. The article of manufacture of claim 27, wherein the ratio is less than approximately 500.

29. The article of manufacture of claim 27, wherein the ratio is less than approximately 125.

30. The article of manufacture of claim 25, wherein the data software system assist is configured to run on the CPU and that is configured to augment at least one data software system.

31. The article of manufacture of claim 25, wherein the hardware accelerator module is configured to augment at least one data software system.

32. The article of manufacture of claim 25, wherein the CPU is coupled via a link to a host.

33. The article of manufacture of claim 25, wherein the CPU is included in a block and wherein the block performs similar operations as a host.

34. The article of manufacture of claim 25, wherein during a cache hit, the CPU checks data lookup for a pointer associated with a logical block address (LBA) and sends a content of a cache line associated with the LBA in response to a read LBA request, wherein the pointer points to a cache header and wherein the cache header is associated with a cache line.

35. The article of manufacture of claim 25, wherein during a cache miss, the CPU set up the non-volatile memory controller to send a content in a section in the non-volatile memory to a free cache line associated with a cache header and sends the content in the free cache line in response to a read LBA request.

36. The article of manufacture of claim 15, wherein during a cache miss, the CPU sets up the non-volatile memory controller to send a content in a section in the non-volatile memory to a free cache line associated with a cache header and sends the content in the free cache line in response to a read LBA request and places the cache header at a location in a list depending on a cache eviction policy of the apparatus.
